(19) United States
(12) Patent Application Publication
(10) Pub. No.: US 2009/0045787 A1
(43) Pub. Date: Feb. 19, 2009

(54) Semiconductor Device and Power Supply Device

(75) Inventor: Hiroki Takeuchi, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/914,974

(22) PCT Filed: Mar. 13, 2006
(86) PCT No.: PCT/JP2006/304855

§ 371 Date: Nov. 20, 2007

(30) Foreign Application Priority Data
May 26, 2005 (JP) 2005-153875

(51) Int. Cl. G05F 1/10

(52) U.S. Cl. 323/273

(57) ABSTRACT

At the time of voltage adjustment, a selector (23) outputs data (D01, D1) externally received, to a current adjustment unit (24). The current adjustment unit (24) changes current (I01) in accordance with the data (D1) so that a voltage (VOUT) changes. The data (D1) obtained when the voltage (VOUT) is determined to be a certain value becomes data (D2) to be stored in a storage unit (22). At the time of a normal operation, the selector (23) provides the data (D2) output from the storage unit (22), to the current adjustment unit (24). Accordingly, even at the time of a normal operation, a power supply circuit (1) can output the voltage (VOUT) of high accuracy. It is therefore possible to provide a semiconductor device capable of outputting a voltage of high accuracy, and a power supply device provided with the semiconductor device.

### TECHNICAL FIELD

The present invention relates to a semiconductor device and a power supply device, and particularly relates to a semiconductor device capable of stably outputting a voltage, and a power supply device provided with the semiconductor device.

### BACKGROUND ART

As a semiconductor device for supplying a stable voltage to a load, a power supply IC (Integrated Circuit) such as a regulator is widely known. To prevent wide variations in properties, namely, variations in output voltage, among products, adjustment for reducing variations in properties is carried out prior to shipment of the products.

Such a semiconductor device is generally provided with a fuse circuit including a plurality of fuses, to adjust an output voltage. During a process of inspecting a semiconductor wafer, some or all of the plurality of fuses included in a semiconductor integrated circuit to be inspected are blown. By blowing the fuses of interest to change a circuit constant, an output voltage value can be adjusted to fall within a prescribed range with reference to a target value.

FIG. 14 is a drawing that shows an example of a circuit including fuses in a conventional semiconductor device. With reference to FIG. 14, an output unit 110 externally outputs a voltage VOUT. Output unit 110 includes a plurality of resistors R100, a resistor R101, a resistor R102, a plurality of fuses F100, and a buffer amplifier B100.

Resistor R101 and the plurality of resistors R100 are connected in series between a node W100 and a node W100. Resistor R102 and the plurality of resistors R100 are connected in series between node W101 and a ground node. The plurality of fuses F100 are provided to correspond to the plurality of resistors R100, respectively, and connected in parallel to corresponding resistors R100, respectively. Buffer amplifier B100 has an input terminal connected to node W101, and an output terminal connected to a node W102.

Voltage VOUT is equal to a voltage at node W101. The voltage at node W101 depends on a resistance value between node W100 and node W101, and a resistance value between node W101 and the ground node. By blowing any of the plurality of fuses F100, it is possible to change these resistance values, and hence change voltage VOUT.

A fuse is blown with the use of, for example, a laser device or the like. After the fuse is blown, voltage VOUT is measured again to determine whether or not voltage VOUT falls within a prescribed range with respect to a target voltage.

FIG. 15 is a drawing that shows another example of the circuit including fuses in the conventional semiconductor device. With reference to FIG. 15, an output unit 120 includes a reference voltage generating circuit 121, a differential amplifier circuit AMP, the plurality of resistors R100, resistor R101, resistor R102, and the plurality of fuses F100. Differential amplifier circuit AMP has a non-inverting input terminal connected to reference voltage generating circuit 121, an inverting input terminal connected to node W101, and an output terminal connected to node W102.

Resistor R101 and the plurality of resistors R100 are connected in series between node W102 and node W101. Resistor R102 and the plurality of resistors R100 are connected in series between node W100 and the ground node. The plurality of fuses F100 are provided to correspond to the plurality of resistors R100, respectively, and connected in parallel to corresponding resistors R100, respectively.

A voltage VREF is a voltage output from reference voltage generating circuit 121. Voltage VOUT is determined in accordance with a difference between voltage VREF and a voltage at node W101. To determine the voltage at node W100, a fuse to be blown is selected out of the plurality of fuses F100, and the selected fuse is blown with a laser device or the like.

As an example of a circuit having an output voltage corrected with a fuse, Japanese Patent Laying-Open No. 9-34562 (Patent Document 1), for example, discloses a voltage correction circuit provided with a level comparison circuit outputting a fuse selection signal based on comparison between an input voltage and a reference voltage, a fuse selection circuit selecting any of a plurality of fuses based on the fuse selection signal and allowing a fuse blowing current to flow through the selected fuse, and a voltage adjustment circuit selecting a correction value for the input voltage based on which fuse has been blown out of the plurality of fuses and correcting the input voltage based on the correction value.

### Patent Document 1: Japanese Patent Laying-Open No. 9-34562

### DISCLOSURE OF THE INVENTION

### Problems to be Solved by the Invention

As to an output voltage, the smaller the deviation is from a target value, the more preferable. In other words, the output voltage is required to have high accuracy. If the output voltage is adjusted by blowing of a fuse, an accuracy of approximately ±1%, for example, is obtained. However, if accuracy of the output voltage is set to be higher (e.g. accuracy is set to be ±0.1%), the conventional adjustment method by blowing of a fuse causes the problems as follows.

Prior to blowing of a fuse, an output voltage is measured with a testing device such as a semiconductor tester to detect an error between the measurement result and a target voltage. Based on the detected error, a fuse to be blown is specified. A fuse to be blown is specified based on, for example, data indicating changes in output voltage with respect to the number of fuses to be blown. The data is the one measured in advance with another semiconductor integrated circuit. Therefore, if the fuse selected based on the data is blown, an output voltage may differ from a predicted result, and hence accuracy of the output voltage cannot be made higher.

Furthermore, owing to variations in manufacturing process, a resistance value of a fusible resistor varies in accordance with its position on the same wafer plane. Accordingly, even if a fuse is blown to adjust an output voltage, accuracy of the output voltage cannot be made higher.

Furthermore, blowing of a fuse with laser light may cause damage to a portion where the laser light is applied. The damaged portion may have a leakage current generated thereat. Under the influence of the leakage current, an output voltage value obtained after blowing of the fuse may significantly deviate from a predicted value.

Furthermore, if a wafer still has many chips having a large difference between an output voltage and a target value even after a fuse-blowing process, it is necessary, for example, for a worker to observe a surface of each chip to examine whether or not a fuse is actually blown. However, a checking method by a worker requires much time and labor and hence contributes to increased cost.

An object of the present invention is to provide a semiconductor device capable of outputting a voltage of high accuracy, and a power supply device provided with the semiconductor device.

### Means for Solving the Problems

To summarize, the present invention is a semiconductor device, including: a voltage output unit changing an output voltage in accordance with a control current input thereto and output therefrom; a current control unit determining a current value of the control current in accordance with control data, and receiving from and outputting to the voltage output unit the control current; and a control data output unit configured to be able to store setting data therein in a nonvolatile manner, and outputting voltage adjustment data input thereto as the control data at the time of voltage adjustment, and outputting the setting data as the control data at the time of a normal operation.

Preferably, the control data includes first data for changing the output voltage at a first rate, and second data for changing the output voltage at a second rate lower than the first rate, and the current control unit includes a first current adjustment unit receiving from and outputting to the voltage output unit the control current in accordance with the first data, and a second current adjustment unit receiving from and outputting to the voltage output unit the control current in accordance with the second data.

More preferably, the voltage output unit includes a first resistor connected between a power supply node and a first node having the control current input thereto and output therefrom, a second resistor connected between the first node and a ground node, and a buffer amplifier having an input terminal connected to the first node and an output terminal connected to a second node outputting the output voltage.

More preferably, the voltage output unit includes a reference voltage generating circuit generating a reference voltage, a differential amplifier circuit receiving the reference voltage at a non-inverting input terminal, and having an inverting input terminal connected to a first node having the control current input thereto and output therefrom, and an output terminal connected to a second node outputting the output voltage, a first resistor connected between the first node and the second node, and a second resistor connected between the first node and a ground node.

More preferably, the control data output unit includes an input unit having the voltage adjustment data externally input thereto, a storage unit storing the setting data in a nonvolatile manner, and a selection unit selecting one of the voltage adjustment data and the setting data as the control data in accordance with a switching signal indicating one of the time of voltage adjustment and the time of the normal operation.

Further preferably, the semiconductor device further includes a monitor data output unit externally outputting the control data received from the selection unit.

Further preferably, the input unit receives correction data for correcting the output voltage to be a target voltage at the time of the normal operation, and the current control unit further includes a third current adjustment unit receiving from and outputting to the voltage output unit the control current in accordance with the correction data provided through the input unit.

According to another aspect of the present invention, the present invention is a power supply device provided with a semiconductor device. The semiconductor device includes a voltage output unit changing an output voltage in accordance with a control current input thereto and output therefrom, a current control unit determining a current value of the control current in accordance with control data, and receiving from and outputting to the voltage output unit the control current, and a control data output unit configured to be able to store setting data therein in a nonvolatile manner, and outputting voltage adjustment data input thereto as the control data at the time of voltage adjustment, and outputting the setting data as the control data at the time of a normal operation.

Preferably, the control data includes first data for changing the output voltage at a first rate, and a second data for changing the output voltage at a second rate lower than the first rate, and the current control unit includes a first current adjustment unit receiving from and outputting to the voltage output unit the control current in accordance with the first data, and a second current adjustment unit receiving from and outputting to the voltage output unit the control current in accordance with the second data.

More preferably, the voltage output unit includes a first resistor connected between a power supply node and a first node having the control current input thereto and output therefrom, a second resistor connected between the first node and a ground node, and a buffer amplifier having an input terminal connected to the first node and an output terminal connected to a second node outputting the output voltage.

More preferably, the voltage output unit includes a reference voltage generating circuit generating a reference voltage, a differential amplifier circuit receiving the reference voltage at a non-inverting input terminal, and having an inverting input terminal connected to a first node having the control current input thereto and output therefrom, and an output terminal connected to a second node outputting the output voltage, a first resistor connected between the first node and the second node, and a second resistor connected between the first node and a ground node.

More preferably, the control data output unit includes an input unit having the voltage adjustment data externally input thereto, a storage unit storing the setting data in a nonvolatile manner, and a selection unit selecting one of the voltage adjustment data and the setting data as the control data in accordance with a switching signal indicating one of the time of voltage adjustment and the time of the normal operation.

Further preferably, the semiconductor device further includes a monitor data output unit externally outputting the control data received from the selection unit.

Further preferably, the input unit receives correction data for correcting the output voltage to be a target voltage at the time of the normal operation, and the current control unit further includes a third current adjustment unit receiving from and outputting to the voltage output unit the control current in accordance with the correction data provided through the input unit.

### EFFECTS OF THE INVENTION

The semiconductor device and the power supply device according to the present invention change an output voltage in accordance with the control data input thereto and stores optimal data identified as the control data for setting the output voltage to be a target voltage, at the time of voltage adjustment, and output the output voltage in accordance with the optimal data at the time of a normal operation. Accordingly, the semiconductor device and the power supply device according to the present invention enable a voltage of high accuracy to be output at the time of a normal operation.

### BRIEF DESCRIPTION OF THE DRAWINGS

FIG. 1 is a drawing that shows an example to which a power supply device mounted with a semiconductor device according to the present invention is applied.

FIG. 2 is a block diagram showing a configuration of a power supply circuit 1 in FIG. 1.

FIG. 3 is a drawing that shows further in detail the configuration of power supply circuit 1 shown in FIG. 2.

FIG. 4 is another drawing that shows further in detail the configuration of power supply circuit 1 shown in FIG. 2.

FIG. 5 is a drawing that shows configurations of an adjustment unit 24A and an adjustment unit 24B in FIG. 4.

FIG. 6 is a circuit diagram showing a practical example of a current input unit 24A1 in FIG. 5.

FIG. 7 is a drawing that shows a configuration of a current output unit 24A2 in FIG. 5.

FIG. 8 is a drawing that shows a configuration of a current unit C1 in FIG. 5.

FIG. 9 is a drawing that shows a configuration of a current unit C2 in FIG. 5.

FIG. 10 is a drawing that shows a configuration of a semiconductor device in a second embodiment.

FIG. 11 is a drawing that shows a configuration of a voltage output unit 26A in FIG. 10.

FIG. 12 is a drawing that shows a configuration of a semiconductor device in a third embodiment.

FIG. 13 is a drawing that shows a configuration of a current adjustment unit 241 in FIG. 12.

FIG. 14 is a drawing that shows an example of a circuit including fuses in a conventional semiconductor device.

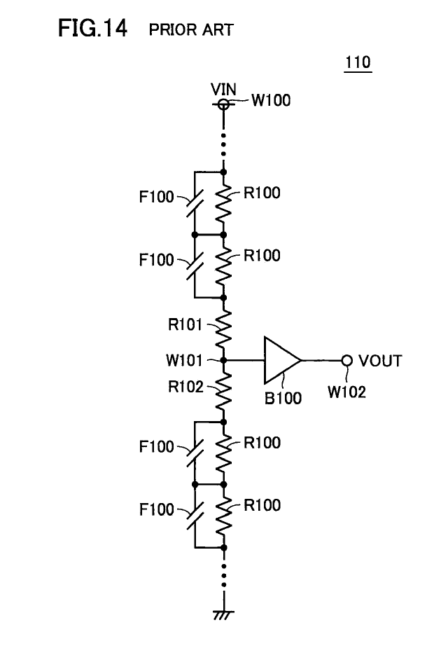

FIG. 15 is a drawing that shows another example of the circuit including fuses in the conventional semiconductor device.

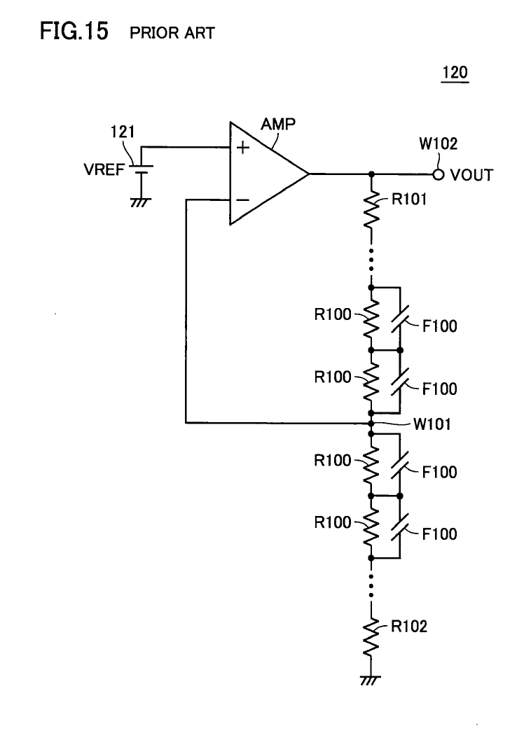

### DESCRIPTION OF THE REFERENCE SIGNS

1, 1A, 1B: power supply circuit, 2: display circuit, 3: control circuit, 11: control data output unit, 21: interface unit, 22: storage unit, 22A, 22B: data retaining unit, 23: selector, 24AD, 24BD: instruction circuit, 24, 241: current adjustment unit, 24A-24C: adjustment unit, 24A1, 24B1: current input unit, 24A2, 24B2: current output unit, 25: monitor data output unit, 25A, 25B: data conversion unit, 26, 26A: voltage output unit, 27, 121: reference voltage generating circuit, 28, AMP: differential amplifier circuit, 31, RA, RB: register, 100: electronic device, 110, 120: output unit, B1, B100: buffer amplifier, C1, C2: current unit, CM1-CM17: current mirror circuit, F100: fuse, M1-M21: N-channel MOS transistor, N0-N25, W0, W1, W100-W102: node, Q0-Q7, Q10A-Q17A, Q10B-Q17B, Q21, Q22: PNP transistor, Q1A-Q7A, Q1B-Q7B, Q11A, Q11B, Q12-Q17, Q23-Q28: NPN transistor, R0-R7, R12-R17, R21-R23, R25, R26, R100-R102, R1A-R7A, R1B-R7B, R10A-R17A, R10B-R17B, RA1, RA2, RB1, RB2: resistor, SA, SB: switching circuit, T1-T4: terminal.

### BEST MODES FOR CARRYING OUT THE INVENTION

Embodiments of the present invention will hereinafter be described in detail with reference to the drawings. Note that the same reference characters represent the same or corresponding portions in these drawings.

### First Embodiment

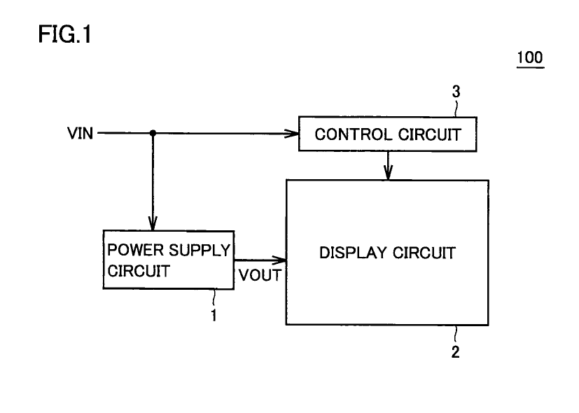

FIG. 1 is a drawing that shows an example to which a power supply device mounted with a semiconductor device according to the present invention is applied. With reference to FIG. 1, an electronic device 100 is, for example, an image display device. Electronic device 100 includes a power supply circuit 1 receiving a voltage VIN and outputting a voltage VOUT, a display circuit 2 receiving voltage VOUT to perform a prescribed process required for image display, and a control circuit 3 receiving voltage VIN to control an operation of display circuit 2. Voltage VIN is a power supply voltage. Note that power supply circuit 1 corresponds to the power supply device according to the present invention.

Upon receiving voltage VIN, power supply circuit 1 outputs voltage VOUT for driving display circuit 2. Voltage VOUT is, for example, a power supply voltage supplied to display circuit 2. Note that voltage VOUT may be input as a signal for setting a function of display circuit 2. For example, voltage VOUT may be a signal for adjusting a gradation of a color in an image displayed on display circuit 2.

Note that although FIG. 1 shows a display device as an example of electronic device 100, the semiconductor device according to the present invention is applicable as a device that supplies constant power source to an electronic device generally used.

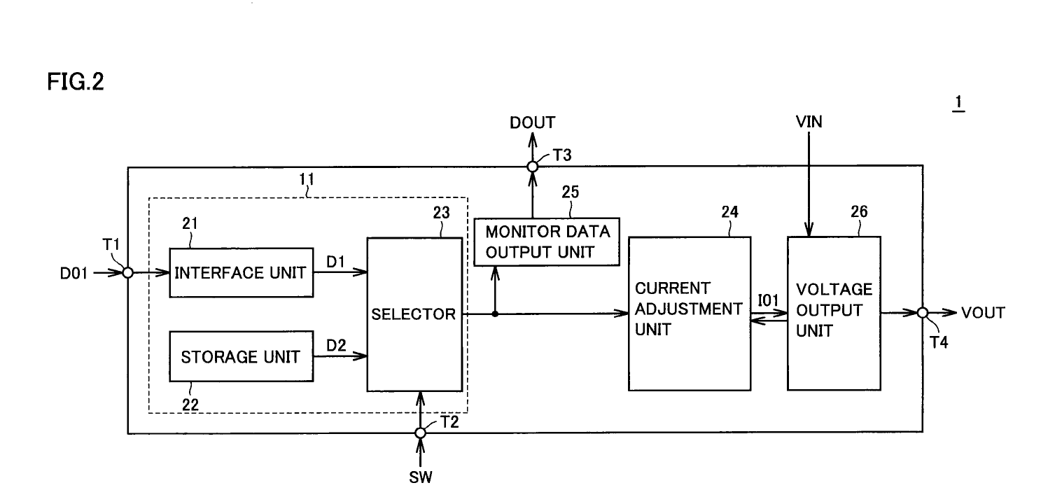

FIG. 2 is a block diagram showing a configuration of power supply circuit 1 in FIG. 1. With reference to FIG. 2, power supply circuit 1 includes a control data output unit 11.

Control data output unit 11 includes an interface unit 21 for externally receiving data D01 through a terminal T1, a storage unit 22 storing data in a nonvolatile manner, and a selector 23.

Interface unit 21 outputs data D1 in accordance with data D01 received at the time of voltage VOUT adjustment. As described below, voltage VOUT changes in accordance with a change in data D01. Interface unit 21 is specifically a serial interface such as a three-wire serial interface or an I2C bus interface. Interface unit 21 converts input serial data (data D01) into parallel data (data D1) and outputs the same.

Storage unit 22 stores data D2 in a nonvolatile manner, and outputs data D2 at the time of a normal operation of power supply circuit 1. Data D2 is parallel data. Storage unit 22 is specifically an electrically rewritable and erasable EEPROM (Electrically Erasable and Programmable Read Only Memory), a fuse circuit including a plurality of fuses, or the like. Note that the “normal operation” refers to an operation of power supply circuit 1 in the state where power supply circuit 1 is packed into electronic device 100 as shown in FIG. 1.

Selector 23 makes a selection as to whether data D1 or data D2 should be output, in accordance with a signal SW input through a terminal T2. If signal SW is at H level, selector 23 outputs data D1. In contrast, if signal SW is at L level, selector 23 outputs data D2. Signal SW is at H level at the time of voltage adjustment and at L level at the time of a normal operation.

Power supply circuit 1 further includes a current adjustment unit 24 outputting a current I01 or drawing current I01 in accordance with data D1 or data D2 output from selector 23, a monitor data output unit 25 externally outputting data output from selector 23, and a voltage output unit 26 changing voltage VOUT to be output, in accordance with an input and an output of current I01.

Note that current adjustment unit 24 corresponds to a current control unit in the present invention, that data D1 or data D2 corresponds to control data in the present invention, and that current I01 corresponds to a control current in the present invention.

An operation of power supply circuit 1 will be described briefly. At the time of voltage adjustment, selector 23 outputs data D01 (data D1) received externally, to current adjustment unit 24. Current adjustment unit 24 changes current I01 in accordance with data D1 so that voltage VOUT changes. Data D1 obtained when voltage VOUT is determined to be a certain value is stored as data D2 in storage unit 22. At the time of a normal operation, selector 23 provides data D2 output from storage unit 22, to current adjustment unit 24. Accordingly, power supply circuit 1 can also output voltage VOUT of high accuracy even at the time of a normal operation.

A method of adjusting voltage VOUT in power supply circuit 1 will be described. Voltage VOUT is adjusted in an inspection process in the state of a semiconductor wafer. In this case, each of terminals T1-T4 represents a pad provided in the circuit.

Initially, prior to adjustment, voltage VOUT is measured with a semiconductor tester (not shown). Next, the semiconductor tester outputs data D01 for adjusting voltage VOUT, in accordance with a difference between the measured value of voltage VOUT and a target value. Accordingly, data D01 is input to interface unit 21.

Furthermore, at the time of voltage VOUT adjustment, the semiconductor tester inputs signal SW at H level to selector 23. Selector 23 outputs data D1 received from interface unit 21 to current adjustment unit 24, in accordance with signal SW at H level.

Current adjustment unit 24 receives or outputs current I01 in accordance with data D1. If data D1 is identified as data for stepping up voltage VOUT, current adjustment unit 24 outputs current I01. If data D1 is identified as data for stepping down voltage VOUT, current adjustment unit 24 receives current I01 from voltage output unit 26.

Voltage output unit 26 changes voltage VOUT in accordance with an input and an output of current I01. If the changed voltage VOUT reaches a prescribed range with respect to a target voltage, data D1 at that time is written as data D2 to storage unit 22. If EEPROM is used as storage unit 22, data D2 is electrically written thereto. If a fuse circuit is used as storage unit 22, data D2 is written by blowing a fuse with laser light.

After the completion of inspection in the wafer state, the wafer is divided into multiple chips, each of which is packed into a package. During packing into a package, each of terminals T1-T4 is wire-bonded to a pin of the package. At this time, terminal T2 is connected to a pin to which a ground potential is provided. Accordingly, when power supply circuit 1 is operated as a finished product, signal SW input to selector 23 is always at L level.

At the time of a normal operation of power supply circuit 1, selector 23 outputs data D2 received from storage unit 22, in accordance with signal SW at L level. Current adjustment unit 24 receives or outputs current I01 in accordance with data D2. Accordingly, at the time of a normal operation, voltage VOUT of high accuracy is output from voltage output unit 26.

Note that the data output from selector 23 is externally output as data DOUT through monitor data output unit 25. It is thereby possible to refer to data D2 even at the time of a normal operation. Note that data DOUT is serial data.

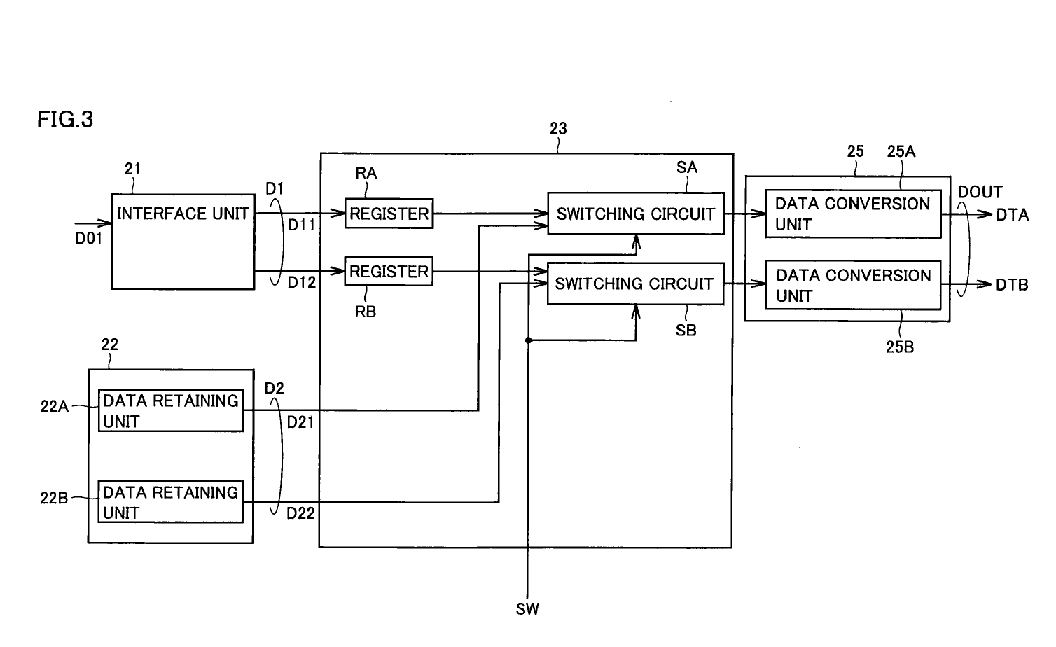

FIG. 3 is a drawing that shows in further detail the configuration of power supply circuit 1 shown in FIG. 2. With reference to FIG. 3, there are shown a configuration of each block of storage unit 22, selector 23, and monitor data output unit 25 in FIG. 2.

Storage unit 22 includes data retaining units 22A, 22B. Data retaining units 22A, 22B retain data D21, D22, respectively, and at the time of a normal operation, output data D21, D22, respectively. Note that data D1 output from interface unit 21 includes data D11 and data D12.

Data D11 is data for bringing voltage VOUT roughly close to a target value. Data D12 is data for finely adjusting voltage VOUT after voltage VOUT is brought close to the target value with data D11. A rate of change in voltage VOUT with respect to an amount of change in data D12 is smaller than that with respect to an amount of change in data D11. Note that data D21 is equal to data D11 determined at the time of voltage adjustment, and that data D22 is equal to data D12 determined at the time of voltage adjustment.

Selector 23 includes registers RA, RB and switching circuits SA, SB. Registers RA, RB are provided to temporarily store data D11, D12, respectively. Switching circuit SA switches itself to output one of data D11 output from register RA and data D21 output from data retaining unit 22A, in accordance with signal SW input thereto. Similarly, switching circuit SB switches itself to output one of data D12 output from register RB and data D22 output from data retaining unit 22B, in accordance with signal SW.

Monitor data output unit 25 includes data conversion units 25A, 25B each converting input parallel data into serial data and outputting the same. Each of data D11, D12, D21, and D22 is parallel data. Data conversion unit 25A converts data D11 or data D21 into serial data, and outputs data DTA as the converted data. Data conversion unit 25B converts data D12 or data D22 into serial data, and outputs data DTB as the converted data. Both of data DTA, DTB is data included in data DOUT.

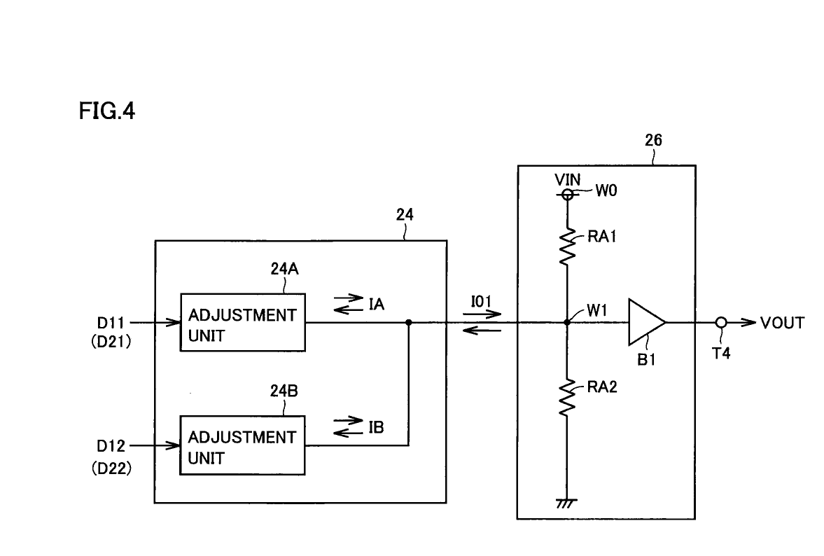

FIG. 4 is another drawing that shows in further detail the configuration of power supply circuit 1 shown in FIG. 2. With reference to FIG. 4, there are shown configurations of current adjustment unit 24 and voltage output unit 26. Current adjustment unit 24 includes adjustment units 24A, 24B.

Adjustment unit 24A receives and outputs current IA in accordance with data D11 (or data D21) input thereto. Adjustment unit 24B receives and outputs current IB in accordance with data D12 (or data D22) input thereto. If adjustment units 24A, 24B output currents IA, IB, respectively, current adjustment unit 24 outputs current I01 that is the sum of currents IA and IB. If currents IA, IB are input to adjustment units 24A, 24B, respectively, current I01 that is the sum of currents IA and IB is input to current adjustment unit 24.

Voltage output unit 26 includes a resistor RA1 connected between a node W0 and a node W1, a resistor RA2 connected between node W1 and a ground node, and a buffer amplifier B1 having an input terminal connected to node W1 and an output terminal connected to terminal T4. Voltage VOUT is equal to a voltage at node W1. Accordingly, voltage VOUT is determined by voltage VIN at node W0, resistance values of resistors RA1, RA2, and current I01. Voltage VOUT is represented in accordance with the following formulas (1)-(3), where the resistance values of resistor RA1, RA2 are denoted as R1, R2, respectively.

VOUT=(R2/R1+R2)×VIN±ΔVN (1)

ΔVN=(R1×R2)/(R1+R2)×I01 (2)

I01=I1×N (3)

Here, N is a value of decimal number, which is determined by the input data D01. ΔVN represents a voltage fluctuation range. I1 represents a current value serving as a unit used for expressing increase and decrease in current I01. In formula (1), ΔVN has a positive sign if current adjustment unit 24 outputs current I01, while ΔVN has a negative sign if current adjustment unit 24 receives current I01.

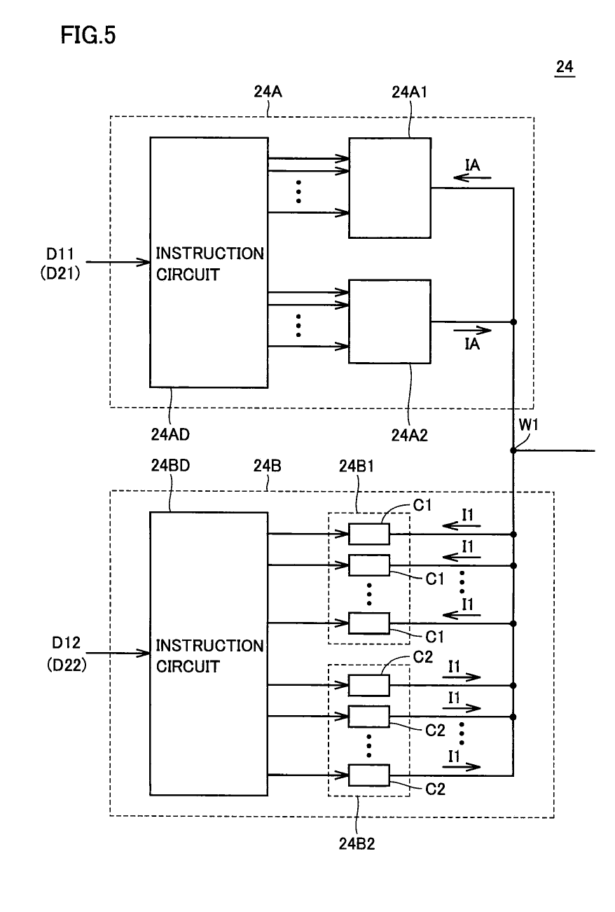

FIG. 5 is a drawing that shows configurations of adjustment unit 24A and adjustment unit 24B in FIG. 4. With reference to FIG. 5, adjustment unit 24A includes an instruction circuit 24AD, a current input unit 24A1, and a current output unit 24A2.

Instruction circuit 24AD sends a voltage signal corresponding to the input data to current input unit 24A1 or current output unit 24A2 in accordance with data D11 (or data D21) input thereto. If current input unit 24A1 receives the signal from instruction circuit 24AD, it receives current IA from node W1. If current output unit 24A2 receives the signal from instruction circuit 24AD, it outputs current IA to node W1.

Data D11 is n-bit data (n is a natural number). Current input unit 24A1 changes current IA from 0 to −(2ⁿ−1)×I1 by I1 in accordance with the signal input from instruction circuit 24AD. Similarly, current output unit 24A2 changes current IA from 0 to +(2ⁿ−1)×I1 by I1 in accordance with the signal input from instruction circuit 24AD. Note that n=7 in the following.

Adjustment unit 24B includes an instruction circuit 24BD, a current input unit 24B1, and a current output unit 24B2.

Instruction circuit 24BD sends a voltage signal corresponding to the input data to current input unit 24B1 or current output unit 24B2 in accordance with data D12 (or data D22) input thereto. If current input unit 24B1 receives the signal from instruction circuit 24BD, it receives current IB from node W1. If current output unit 24B2 receives the signal from instruction circuit 24BD, it outputs current IB to node W1.

Current input unit 24B1 includes a plurality of current units C1 each receiving current I1 from node W1. Current output unit 24B2 includes a plurality of current units C2 each outputting current I1 to node W1. The number of each of current units C1, C2 is set as appropriate.

By configuring adjustment unit 24B as such, current adjustment unit 24 can output current I01, which is shown in formula (3) above, to voltage output unit 26, or draw current I01 from voltage output unit 26, in the case where a value of the control data is N.

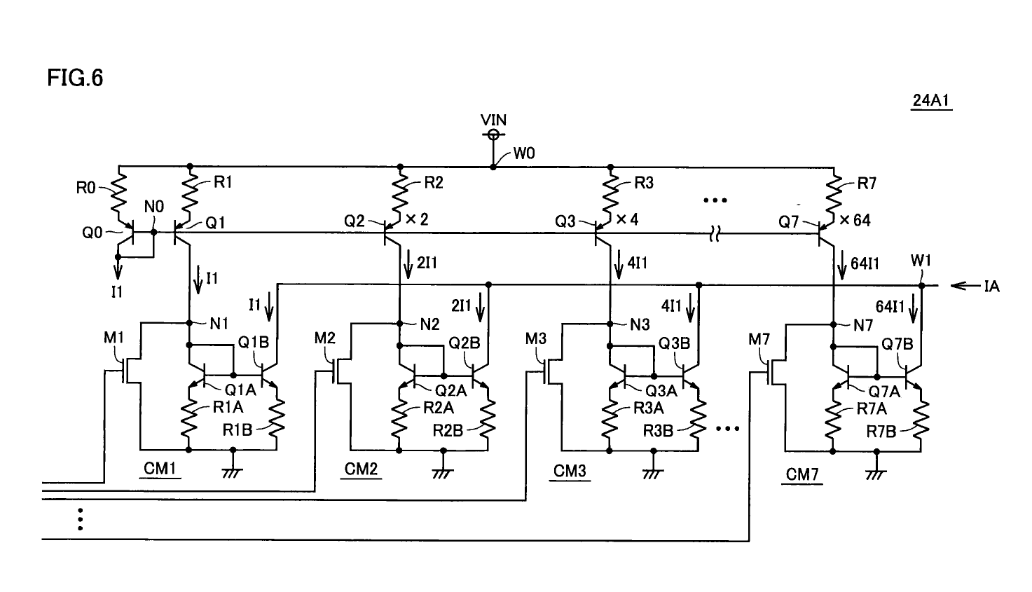

FIG. 6 is a circuit diagram showing a practical example of current input unit 24A1 in FIG. 5. With reference to FIG. 6, current input unit 24A1 includes resistors R0-R7 and PNP transistors Q0-Q7.

Resistor R0 has one terminal connected to node W0. PNP transistor Q0 has an emitter connected to the other terminal of resistor R0, and a base and a collector connected to a node N0. Current I1 is output from the collector of PNP transistor Q0.

Resistor R1 has one terminal connected to node W0. PNP transistor Q1 has an emitter connected to the other terminal of resistor R1, a base connected to node N0, and a collector connected to a node N1.

Similarly, resistors R2-R7 have terminals on one side commonly connected to node W0. PNP transistors Q2-Q7 have emitters connected to terminals on the other side of resistors R2-R7, respectively. PNP transistors Q2-Q7 have bases commonly connected to node N0. PNP transistors Q2-Q7 have collectors connected to nodes N2-N7, respectively.

Resistors R0-R7 and PNP transistors Q0-Q7 configure a current mirror circuit having seven outputs. A current of 2^{m-1}×I1 flows through PNP transistor Qm (m is a natural number of 1-7).

Current input unit 24A1 further includes current mirror circuits CM1-CM7 having the same configuration with respect to one another.

Current mirror circuit CM1 includes NPN transistors Q1A, Q1B, resistors R1A, R1B, and an N-channel MOS transistor M1.

NPN transistor Q1A has a collector and a base connected to node N1. NPN transistor Q1B has a collector connected to node W1 and a base connected to node N1. Resistor R1A has one terminal connected to an emitter of NPN transistor Q1A, and the other terminal connected to the ground node. Resistor R1B has one terminal connected to an emitter of NPN transistor Q1B, and the other terminal connected to the ground node. N-channel MOS transistor M1 is connected between node N1 and the ground node. The N-channel MOS transistor has a gate connected to instruction circuit 24AD in FIG. 5.

Note that current mirror circuit CM2 is configured such that, in the configuration of current mirror circuit CM1, NPN transistors Q1A, Q1B are replaced by NPN transistors Q2A, Q2B, resistors R1A, R1B are replaced by resistors R2A, R2B, N-channel MOS transistor M1 is replaced by an N-channel MOS transistor M2, and node N1 is replaced by node N2. NPN transistors Q2A, Q2B have current capability twice as high as that of NPN transistors Q1A, Q1B. A configuration of other portions in current mirror circuit CM2 is similar to that of current mirror circuit CM1, and hence the description thereof will not be repeated.

Similarly, current mirror circuit CM3 is configured such that, in the configuration of current mirror circuit CM1, NPN transistors Q1A, Q1B are replaced by NPN transistors Q3A, Q3B, resistors R1A, R1B are replaced by resistors R3A, R3B, N-channel MOS transistor M1 is replaced by an N-channel MOS transistor M3, and node N1 is replaced by node N3. NPN transistors Q3A, Q3B have current capability four times as high as that of NPN transistors Q1A, Q1B. A configuration of other portions in current mirror circuit CM3 is similar to that of current mirror circuit CM1, and hence the description thereof will not be repeated.

Similarly, current mirror circuit CM7 is configured such that, in the configuration of current mirror circuit CM1, NPN transistors Q1A, Q1B are replaced by NPN transistors Q7A, Q7B, resistors R1A, R1B are replaced by resistors R7A, R7B, N-channel MOS transistor M1 is replaced by an N-channel MOS transistor M7, and node N1 is replaced by node N7. NPN transistors Q7A, Q7B have current capability 64 times as high as that of NPN transistors Q1A, Q1B. A configuration of other portions in current mirror circuit CM7 is similar to that of current mirror circuit CM1, and hence the description thereof will not be repeated.

An operation of current mirror circuit CM1 will be described. Note that an operation of each of current mirror circuits CM2-CM7 is similar to that of current mirror circuit CM1, and hence the description thereof will not be repeated.

N-channel MOS transistor M1 is made nonconductive when a voltage corresponding to data “0” is applied to the gate, and made conductive when a voltage corresponding to data “1” is applied to the gate. When N-channel MOS transistor M1 is nonconductive, NPN transistor Q1A operates. In this case, PNP transistor Q1 outputs current I1, while NPN transistor Q1A receives current I1 from PNP transistor Q1. In response to current I1 flowing through NPN transistor Q1A, current I1 also flows through NPN transistor Q1B. Accordingly, current I1 flows from node W1 to NPN transistor Q1B.

When N-channel MOS transistor M1 is made conductive, a potential at node N1 is equal to a ground potential, and hence NPN transistor Q1A does not operate. Since current I1 does not flow through NPN transistor Q1A, NPN transistor Q1B does not operate. Accordingly, no current flows from node W1 to NPN transistor Q1B.

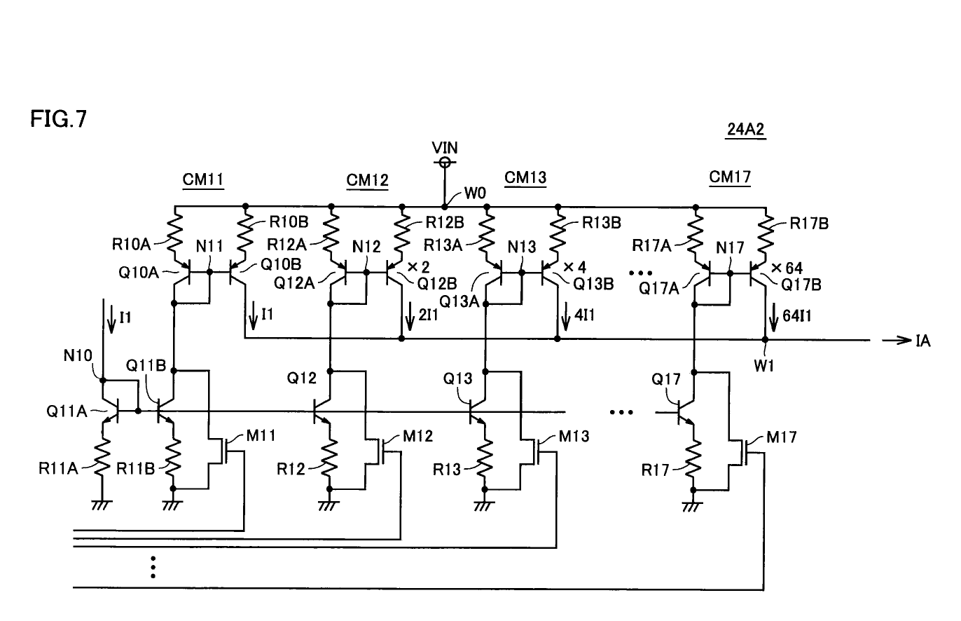

FIG. 7 is a drawing that shows a configuration of current output unit 24A2 in FIG. 5. With reference to FIG. 7, current output unit 24A2 includes NPN transistors Q11A, Q11B, Q12-Q17, resistors R11A, 11B, R12-R17, and N-channel MOS transistors M11-M17.

NPN transistor Q11A has a collector and a base connected to a node N10. NPN transistor Q11B has a collector connected to a node N11, and a base connected to node N10. Resistor R11A is connected between an emitter of NPN transistor Q11A and the ground node. Resistor R11B is connected between an emitter of NPN transistor Q11B and the ground node.

Similarly, collectors of NPN transistors Q2-Q7 are connected to nodes N12-N17, respectively. Bases of NPN transistors Q12-Q17 are commonly connected to node N10. Emitters of NPN transistors Q12-Q17 are connected to terminals on one side of resistors R12-R17, respectively. Each of resistors R12-R17 has a terminal on the other side connected to the ground node.

As in current input unit 24A1 shown in FIG. 6, NPN transistors Q11A, Q11B, Q12-Q17, and resistors R11A, 11B, R12-R17 configure a current mirror circuit having seven outputs. Current I1 flows through NPN transistor Q11B, while a current of 2^{m-1}×I1 flows through NPN transistor Q1m (m is a natural number of 2-7).

N-channel MOS transistors M11-M17 are connected between collectors of NPN transistors Q11B, Q12-Q17 and the ground node, respectively. Each gate of N-channel MOS transistors M11-M17 is connected to instruction circuit 24BD in FIG. 5.

Current output unit 24A2 further includes current mirror circuits CM11-CM17 having the same configuration with respect to one another.

Current mirror circuit CM11 includes PNP transistors Q10A, Q10B, and resistors R10A, R10B. PNP transistor Q10A has a collector and a base connected to node N11. PNP transistor Q10B has a collector connected to node W0 and a base connected to node N11. Resistor R10A is connected between an emitter of PNP transistor Q10A and node W0. Resistor R1B is connected between an emitter of PNP transistor Q10B and node W0.

Current mirror circuit CM12 is configured such that, in the configuration of current mirror circuit CM11, PNP transistors Q10A, Q10B are replaced by PNP transistors Q12A, Q12B, resistors R10A, R10B are replaced by resistors R12A, R12B, and node N11 is replaced by node N2. Note that PNP transistors Q12A, Q12B have current capability twice as high as that of PNP transistors Q11A, Q11B. A configuration of other portions in current mirror circuit CM12 is similar to that of current mirror circuit CM11, and hence the description thereof will not be repeated.

Similarly, current mirror circuit CM13 is configured such that, in the configuration of current mirror circuit CM11, PNP transistors Q10A, Q10B are replaced by PNP transistors Q13A, Q13B, resistors R10A, R10B are replaced by resistors R13A, R13B, and node N11 is replaced by node N13. Note that PNP transistor Q13A, Q13B have current capability four times as high as that of PNP transistors Q11A, Q11B. A configuration of other portions in current mirror circuit CM13 is similar to that of current mirror circuit CM11, and hence the description thereof will not be repeated.

Similarly, current mirror circuit CM17 is configured such that, in the configuration of current mirror circuit CM11, PNP transistors Q10A, Q10B are replaced by PNP transistors Q17A, Q17B, resistors R10A, R10B are replaced by resistors R17A, R17B, and node N11 is replaced by node N17. Note that PNP transistors Q17A, Q17B have current capability 64 times as high as that of PNP transistors Q11A, Q11B. A configuration of other portions in current mirror circuit CM17 is similar to that of current mirror circuit CM11, and hence the description thereof will not be repeated.

N-channel MOS transistor M11 is made nonconductive when a voltage corresponding to data “0” is applied to the gate, and is made conductive when a voltage corresponding to data “1” is applied to the gate. When N-channel MOS transistor M11 is nonconductive, current mirror circuit CM11 outputs current I01 to node W0. When N-channel MOS transistor M11 is conductive, NPN transistor Q11B does not operate, and hence current mirror circuit CM 11 does not output current I01. Note that an operation of each of current mirror circuits CM12-CM17 is similar to that of current mirror circuit CM11, and hence the description thereof will not be repeated.

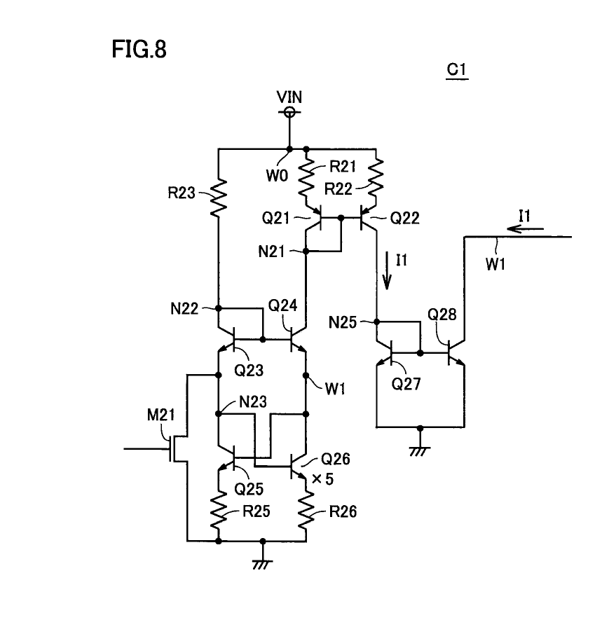

FIG. 8 is a drawing that shows a configuration of current unit C1 in FIG. 5. With reference to FIG. 8, current unit C1 includes resistors R21, R22, and PNP transistors Q21, Q22. Resistor R21 has one terminal connected to node W0. PNP transistor Q21 has an emitter connected to the other terminal of resistor R21, and a base and a collector connected to a node N21. Resistor R22 has one terminal connected to node W0. PNP transistor Q22 has an emitter connected to the other terminal of resistor R22, a base connected to a node N21, and a collector connected to a node N25. Current I1 is output from a collector of PNP transistor Q22.

Current unit C1 further includes a resistor R23, and NPN transistors Q23, Q24. Resistor R23 is connected between node W0 and a node N22. NPN transistor Q23 has a collector and a base connected to node N22, and an emitter connected to a node N23. NPN transistor Q24 has a collector connected to node N21, a base connected to node N22, and an emitter connected to a node N24.

Current unit C1 further includes NPN transistors Q25, Q26, and resistors R25, R26. NPN transistor Q25 has a collector connected to node N23, a base connected to node N24, and an emitter connected to one terminal of resistor R25. NPN transistor Q26 has a collector connected to node N24, a base connected to node N23, and an emitter connected to one terminal of resistor R26. Each of resistors R25, R26 has the other terminal connected to the ground node.

Current unit C1 further includes NPN transistors Q27, Q28. NPN transistor Q27 has a collector and a base commonly connected to node N25, and an emitter connected to the ground node. NPN transistor Q28 has a collector connected to node W1, a base connected to node N25, and an emitter connected to the ground node.

Current unit C1 further includes an N-channel MOS transistor M21 that is connected between node N23 and the ground node, and made conductive upon receiving a voltage corresponding to data “1” at the gate, and made nonconductive upon receiving a voltage corresponding to data “0” at the gate. The gate of N-channel MOS transistor M21 is connected to instruction circuit 24BD shown in FIG. 5.

NPN transistor Q26 has a current supply capability five times as high as that of NPN transistor Q25. Current I1 is shown as in the following formula (4), where a resistance value of resistor R26 is denoted as Rbias.

I1=VT ln 5/Rbias (4)

Here, VT represents a thermal voltage.

An operation of current unit C1 is similar to that of each of current mirror circuits CM1-CM17 shown in FIGS. 5, 6. In other words, when N-channel MOS transistor M21 is nonconductive, current unit C1 receives current I1 from node W1. In contrast, when N-channel MOS transistor M21 is conductive, NPN transistor Q25 is turned off, and hence current I1 does not flow from node W1 to current unit C1.

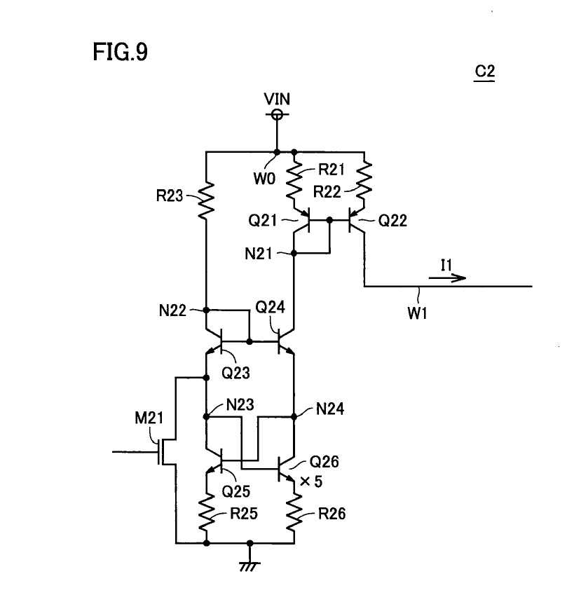

FIG. 9 is a drawing that shows a configuration of current unit C2 in FIG. 5. With reference to FIG. 9, current unit C2 is different from current unit C1 in FIG. 8 in that PNP transistor Q22 has a collector connected to node W1, and PNP transistors Q27, Q28 are not included therein. However, a configuration of other portions is similar, so that the description thereof will not be repeated. When N-channel MOS transistor M21 is nonconductive, current unit C2 outputs current I1 to node W1. When N-channel MOS transistor M21 is conductive, current unit C2 does not output current I1.

Power supply circuit 1 can adjust voltage VOUT to fall within a range of +½ΔVN with respect to a target value, by changing current I01 by current I1. For example, assume that a target value is 15V and ΔVN is 5 mV. If voltage VOUT prior to adjustment is 15 V+4 mV, power supply circuit 1 can lower voltage VOUT by ΔVN. Accordingly, the adjusted voltage is 15V-0.1 mV. In other words, voltage VOUT is adjusted to fall within a range of the target value ±½ ΔVN.

As described above, according to the first embodiment, it is possible to output a voltage adjusted with high accuracy at any time by adjusting a current to be supplied to the output unit in accordance with the input data to thereby adjust an output voltage, and storing optimal data.

### Second Embodiment

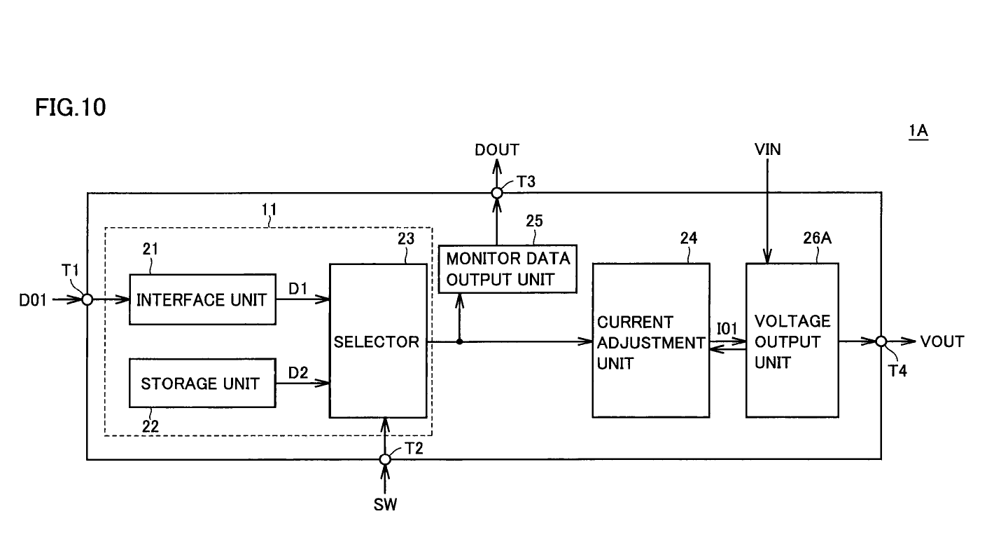

FIG. 10 is a drawing that shows a configuration of a semiconductor device in a second embodiment. With reference to FIG. 10, a power supply circuit 1A is different from power supply circuit 1 in FIG. 2 in that it includes a voltage output unit 26A instead of voltage output unit 26. However, a configuration of other portions in power supply circuit 1A is similar to that of the corresponding portions in power supply circuit 1, and hence the description thereof will not be repeated.

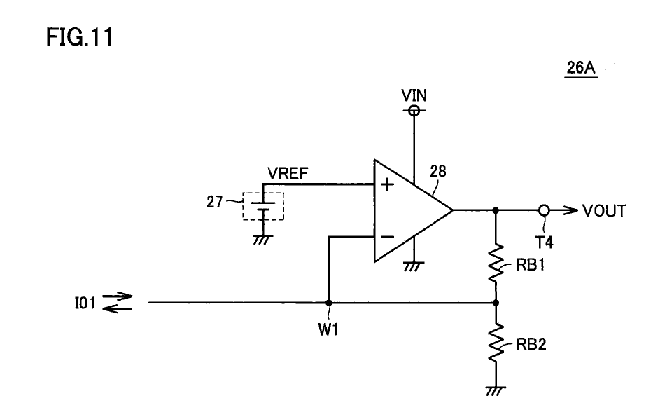

FIG. 11 is a drawing that shows a configuration of voltage output unit 26A in FIG. 10. With reference to FIG. 11, voltage output unit 26A includes a reference voltage generating circuit 27 outputting voltage VREF as a reference voltage, a differential amplifier circuit 28, and resistors RB1, RB2. Differential amplifier circuit 28 receives the reference voltage at a non-inverting input terminal, and has an inverting input terminal connected to node W1. Differential amplifier circuit 28 has an output terminal connected to terminal T4. Resistor RB1 is connected between terminal T4 and node W1. Resistor RB2 is connected between node W1 and the ground node in series.

In the second embodiment, voltage VOUT is represented by the following formulas (5)-(7).

VOUT=(R1+R2)/R2×VREF+ΔVN (5)

ΔVN=R1×N×I01 (6)

or ΔVN=−R2×N×I01 (7)

ΔVN shown in formula (6) is a voltage fluctuation range when current I01 is output from current adjustment unit 24. ΔVN shown in formula (7) is a voltage fluctuation range when current I01 is input to current adjustment unit 24.

As shown in FIG. 4, in the first embodiment, voltage output unit 26 is configured with resistors RA1, RA2, and buffer amplifier B1. The first embodiment has an advantage that the voltage output unit is easily configured. In the first embodiment, however, voltage VOUT varies as voltage VIN varies.

As shown in FIG. 11, voltage output unit 26A includes differential amplifier circuit 28. Accordingly, even if voltage VIN varies, voltage VOUT is less likely to vary, which makes it possible to stabilize voltage VOUT.

As described above, according to the second embodiment, it is possible to stabilize an output voltage by providing a differential amplifier circuit in the output unit.

### Third Embodiment

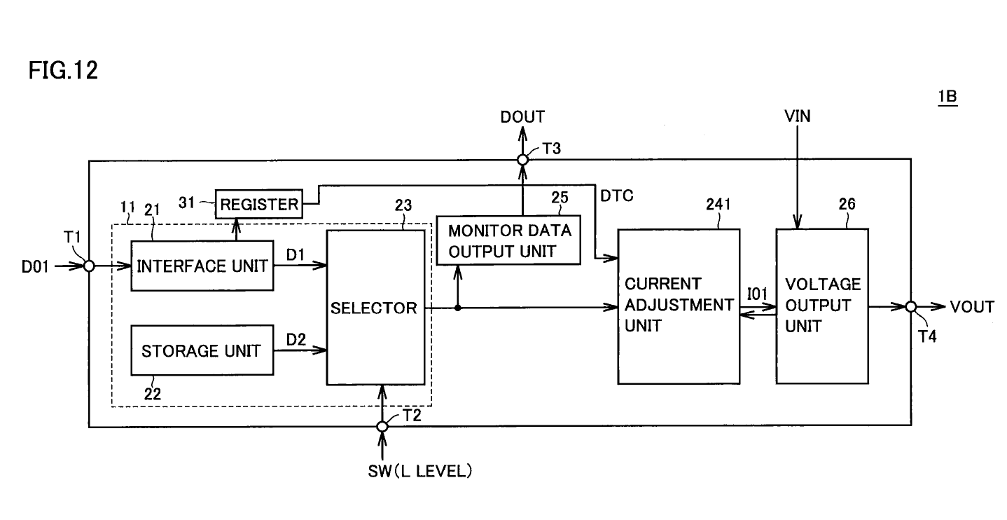

FIG. 12 is a drawing that shows a configuration of a semiconductor device according to a third embodiment. With reference to FIG. 12, a power supply circuit 1B is different from power supply circuit 1 in FIG. 2 in that it further includes a register 31 temporarily storing data output from interface unit 21. Furthermore, power supply circuit 1B is different from power supply circuit 1 in that it includes a current adjustment unit 241 instead of current adjustment unit 24. However, a configuration of other portions in power supply circuit 1B is similar to that of power supply circuit 1, and hence the description thereof will not be repeated.

Register 31 temporarily stores data received from interface unit 21 in the state where signal SW is at L level, namely, at the time of a normal operation. Accordingly, once data is externally provided to power supply circuit 1B, the data is retained in register 31 while voltage VIN is being supplied. Note that the data DTC stored in register 31 is sent to current adjustment unit 241.

In the first and second embodiments, when a semiconductor chip is packed into a package, selector 23 sends data D2 from storage unit 22 to current adjustment unit 24. Accordingly, if accuracy of voltage VOUT is lowered owing to long-term use, voltage VOUT cannot be adjusted in the first and second embodiments. In contrast, in the third embodiment, it is also possible even at the time of a normal operation to adjust voltage VOUT in accordance with data D01 (correction data) input thereto and set voltage VOUT to a target voltage. Note that data D01 is sent, for example, from control circuit 3, memory, or the like in FIG. 1.

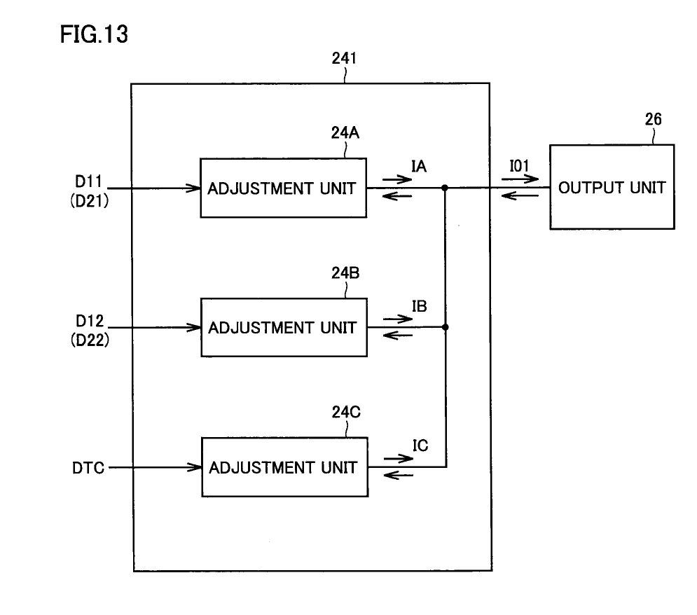

FIG. 13 is a drawing that shows a configuration of current adjustment unit 241 in FIG. 12. With reference to FIG. 12, current adjustment unit 241 is different from current adjustment unit 24 in FIG. 4 in that it further includes an adjustment unit 24C. However, a configuration of other portions is similar, and hence the description thereof will not be repeated.

Adjustment unit 24C receives and outputs current IC in accordance with data DTC received from interface unit 21 through register 31. Current I01 is the sum of currents IA, IB and IC. Note that a configuration of adjustment unit 24C is similar to that of adjustment unit 24B, and hence the description thereof will not be repeated.

As described above, according to the third embodiment, it is possible to adjust an output voltage at the time of a normal operation by sending data input to the interface unit, to the current adjustment unit.

It should be understood that the embodiments disclosed herein are illustrative and not limitative in all aspects. The scope of the present invention is shown not by the description above but by the scope of the claims, and is intended to include all modifications within the equivalent meaning and scope of the claims.

1. A semiconductor device, comprising:
a voltage output unit to change an output voltage in accordance with a control current input thereto and output therefrom;
a current control unit to determine a current value of said control current in accordance with control data, and to receive from and provide to said voltage output unit said control current; and
a control data output unit configured to be able to store setting data therein in a nonvolatile manner, to provide voltage adjustment data input thereto as said control data at the time of voltage adjustment, and to provide said setting data as said control data at the time of a normal operation.

2. The semiconductor device according to claim 1, wherein
said control data includes
first data for changing said output voltage at a first rate, and
second data for changing said output voltage at a second rate lower than the first rate, and
said current control unit includes:
a first current adjustment unit to receive from and outputting to said voltage output unit said control current in accordance with said first data, and
a second current adjustment unit to receive from and outputting to said voltage output unit said control current in accordance with said second data.

3. The semiconductor device according to claim 2, wherein said voltage output unit includes:
a first resistor connected between a power supply node and a first node having said control current input thereto and output therefrom,
a second resistor connected between said first node and a ground node, and
a buffer amplifier having an input terminal connected to said first node and an output terminal connected to a second node outputting said output voltage.

4. The semiconductor device according to claim 2, wherein
said voltage output unit includes:
a reference voltage generating circuit to generate generating a reference voltage,
a differential amplifier circuit to receive said reference voltage at a non-inverting input terminal, and having an inverting input terminal connected to a first node having said control current input thereto and output therefrom, and an output terminal connected to a second node to provide said output voltage,
a first resistor connected between said first node and said second node, and
a second resistor connected between said first node and a ground node.

5. The semiconductor device according to claim 2, wherein said control data output unit includes:
an input unit having said voltage adjustment data externally input thereto,
a storage unit to store said setting data in a nonvolatile manner, and
a selection unit to selecting one of said voltage adjustment data and said setting data as said control data in accordance with a switching signal indicating one of said time of voltage adjustment and said time of the normal operation.

6. The semiconductor device according to claim 5, further comprising a monitor data output unit to provide externally said control data received from said selection unit.

7. The semiconductor device according to claim 5, wherein
said input unit is configured to receive correction data for correcting said output voltage to be a target voltage at said time of the normal operation, and
said current control unit further includes a third current adjustment unit to receive from and provide to said voltage output unit said control current in accordance with said correction data provided through said input unit.

8. A power supply device, comprising a semiconductor device, wherein said semiconductor device includes:
a voltage output unit change an output voltage in accordance with a control current input thereto and output therefrom,
a current control unit to determine a current value of said control current in accordance with control data, and to receive from and provide to said voltage output unit said control current, and
a control data output unit configured to store setting data therein in a nonvolatile manner, to provide voltage adjustment data input thereto as said control data at the time of voltage adjustment, and to provide said setting data as said control data at the time of a normal operation.

9. The power supply device according to claim 8, wherein said control data includes:
first data for changing said output voltage at a first rate, and
a second data for changing said output voltage at a second rate lower than the first rate, and
said current control unit includes:
a first current adjustment unit receiving to receive from and provide to said voltage output unit said control current in accordance with said first data, and
a second current adjustment unit to receive from and provide to said voltage output unit said control current in accordance with said second data.

10. The power supply device according to claim 9, wherein said voltage output unit includes:
a first resistor connected between a power supply node and a first node having said control current input thereto and output therefrom,
a second resistor connected between said first node and a ground node, and
a buffer amplifier having an input terminal connected to said first node and an output terminal connected to a second node outputting said output voltage.

11. The power supply device according to claim 9, wherein
said voltage output unit includes:
a reference voltage generating circuit to generate a reference voltage
a differential amplifier circuit to receive said reference voltage at a non-inverting input terminal, and having an inverting input terminal connected to a first node having said control current input thereto and output therefrom, and an output terminal connected to a second node outputting said output voltage,
a first resistor connected between said first node and said second node, and
a second resistor connected between said first node and a ground node.

12. The power supply device according to claim 9, wherein said control data output unit includes:
an input unit having said voltage adjustment data externally input thereto,
a storage unit to store said setting data in a nonvolatile manner, and
a selection unit to select one of said voltage adjustment data and said setting data as said control data in accordance with a switching signal indicating one of said time of voltage adjustment and said time of the normal operation.

13. The power supply device according to claim 12, wherein said semiconductor device further includes a monitor data output unit configured to provide externally said control data received from said selection unit.

14. The power supply device according to claim 12, wherein
said input unit is configured to receive correction data for correcting said output voltage to be a target voltage at said time of the normal operation, and
said current control unit further includes a third current adjustment unit to receive from and provide to said voltage output unit said control current in accordance with said correction data provided through said input unit.
